(19) United States
(12) Patent Application Publication
(10) Pub. No.: US 2004/0064986 A1
(43) Pub. Date: Apr. 8, 2004

(54) Wall-integrated roll-up decoration for concealing objects

(76) Inventor: William Henry Anderson, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/264,083

(22) Filed: Oct. 3, 2002

(51) Int. Cl. G09F 11/18

(52) U.S. Cl. 40/515

(57) ABSTRACT

A frame surrounds a framed area. The frame has an interior side and an exterior side opposite the interior side. An object to be displayed at certain times, such as a television set, is placed within the framed area. A flexible canvas cover has an area that is greater than or equal to the framed area. A storage roll is secured to the flexible canvas cover, thereby allowing the flexible canvas cover to be rolled onto the storage roll. A roll driver mechanism is securably attached to the interior side of the frame. The roll driver mechanism rotates the storage roll, thereby moving the flexible canvas cover between a deployed position and a retracted position. In the deployed position, the flexible canvas cover covers the framed area; in the retracted position, the flexible canvas cover is rolled onto the storage roll, and is positioned adjacent to the interior side of the frame.

### BACKGROUND OF THE INVENTION

1. Field of the Invention

The present invention relates generally to decorative furnishings, and relates specifically to a retractable decorative cover configured to conceal a television set.

2. Description of the Related Art

It is common to use one's dwelling for a wide variety of purposes, such as for the display of a fine art collection, for personal home video entertainment (i.e., for viewing of video recordings or television broadcasts) or simply as a quiet place for relaxation. While it may be desirable to have different rooms which are specially adapted and furnished for these and other purposes, such an arrangement is often prohibitively expensive. Thus, it is generally desirable to have a room capable of being used for multiple purposes.

While multipurpose rooms are convenient and cost-effective in the sense that they eliminate the need to have multiple rooms that are each configured for a specific purpose, there are several disadvantages associated with conventional multipurpose rooms. For example, a multipurpose room configured to be used for personal home video entertainment and for displaying a fine art collection may include accessories specifically adapted for each application. Specifically, such a room might contain both audio/visual accessories (such as a television set, a stereo receiver, or loudspeakers) as well as art display accessories (such as frames, pedestals, or specialized lighting). The placement of all such items in a multipurpose room may increase the convenience of the room by eliminating the need to move certain items into and out of the room before and after certain uses of the room. However, it may be undesirable, for example, to display a fine art collection in a room which also contains a television set. For example, the presence of a large television set may detract from the viewing pleasure of, and ambience created by, the fine art collection.

Thus, a wall-integrated roll-up decoration for concealing objects that allows certain objects in a multipurpose room to be hidden when appropriate is desired. Such a system would increase the utility of the conventional multipurpose room by eliminating the need to move certain items (for example, a television set) into and out of a multipurpose room before and after certain uses of the room (for example, a fine art exhibition).

Additionally, as housing costs increase, it has become increasingly difficult to afford large living spaces. Smaller living spaces are more affordable, but provide a smaller space for wall-displayed objects such as artwork, photographs, drawings, certificates or corporate logos. This problem is exacerbated with the advent of flat-panel television sets, which further consume the already limited about of wall space for displaying objects. Thus, it is further desired to maximize the use of wall space available for hanging objects in a room with a limited amount of wall space. In particular, it is desired to place a flat-panel television set in a room without consuming additional wall space.

Finally, it is desired to protect expensive video display equipment when such equipment is not in use. The various embodiments of the wall-integrated roll-up decoration for concealing objects described herein address these desires.

### SUMMARY IF THE INVENTION

According to one aspect of the present invention, an apparatus comprises a frame surrounding a framed area. The frame has an interior side and an exterior side opposite the interior side. The apparatus further comprises a flexible canvas cover with an area that is greater than or equal to the framed area. A storage roll is connected to the flexible canvas cover, thereby allowing the flexible canvas cover to be rolled onto the storage roll. The apparatus further comprises a roll driver mechanism securably attached to the interior side of the frame. The roll driver mechanism is configured to rotate the storage roll, thereby causing the flexible canvas cover to move between a deployed position and a retracted position. In the deployed position, the flexible canvas cover covers the framed area; in the retracted position, the flexible canvas cover is rolled onto the storage roll, and is positioned adjacent to the interior side of the frame.

According to another aspect of the present invention, a method comprises positioning a frame around the perimeter of a video display. The frame has an interior side and an exterior side opposite the interior side. The method further comprises securably attaching a storage roll to the interior side of the frame, and securably attaching a flexible canvas cover to the storage roll. The method further comprises rolling the flexible canvas cover onto the storage roll when the video display is to be viewed, and unrolling the flexible canvas cover from the storage roll when the flexible canvas cover is to be viewed.

### BRIEF DESCRIPTION OF THE DRAWINGS

Having thus summarized the general nature of the invention and its features and advantages, certain preferred embodiments and modifications thereof will become apparent to those skilled in the art from the detailed description herein having reference to the figures that follow.

FIG. 1 is a front view of one embodiment of a wall-integrated roll-up decoration for concealing objects.

FIG. 2A is a cross-sectional view of the embodiment illustrated in FIG. 1 taken along line 2A-2A.

FIG. 2B is a schematic diagram of a wall-integrated roll-up decoration for concealing a flat-panel television set.

FIG. 3 is a cross-sectional view of the embodiment illustrated in FIG. 2A taken along line 3-3.

FIG. 4A is a schematic diagram of a wall-integrated roll-up decoration for concealing objects wherein the roll driver mechanism is integral with a wall surrounding a cutout shelf.

FIG. 4B is a schematic diagram of a wall-integrated roll-up decoration for concealing objects wherein the roll driver mechanism is integral with a wall-mounted frame surrounding a cutout shelf.

### DETAILED DESCRIPTION OF THE PREFERRED EMBODIMENTS

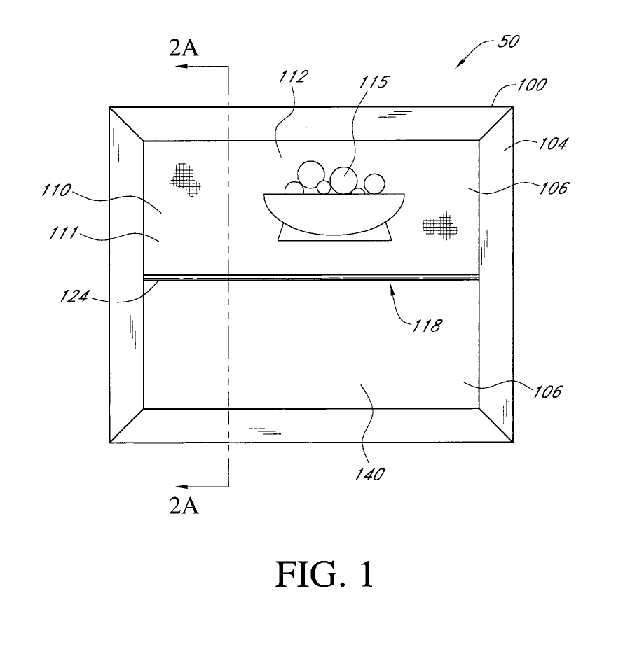

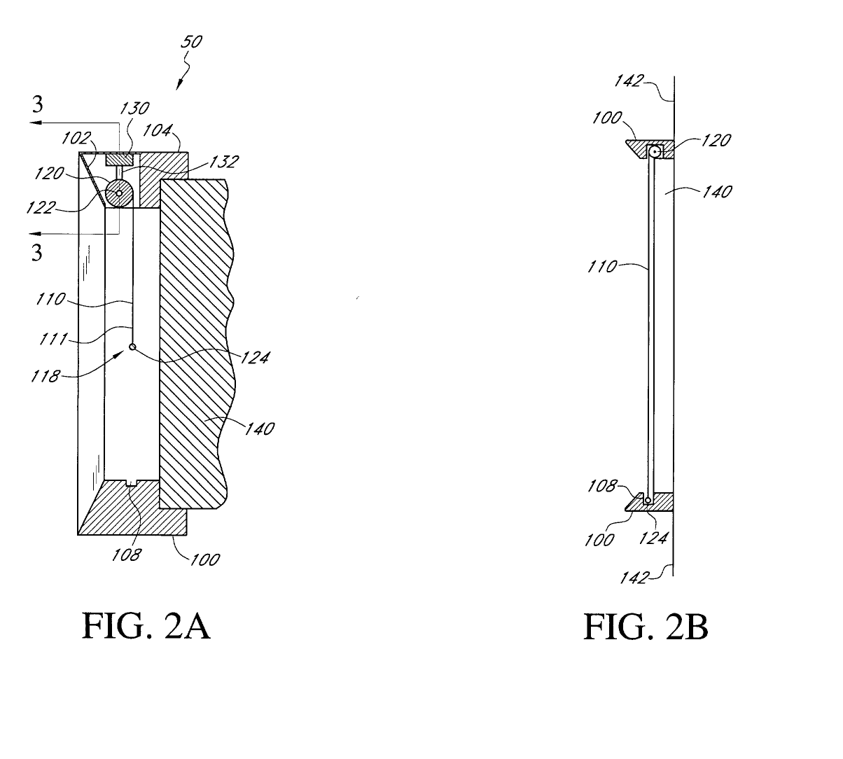

FIGS. 1 and 2A illustrate a preferred embodiment of a wall-integrated roll-up decoration for concealing objects 50. The wall-integrated roll-up decoration for concealing objects comprises a frame 100 surrounding a framed area 106. The frame 100 has an interior side 102 and an exterior side 104. The roll-up decoration further comprises a flexible cover 110 having an area 112 greater than or equal to the framed area 106. The flexible cover 110 further comprises a first end and a second end opposite the first end. The roll-up decoration further comprises a storage roll 120 removably secured to the first end of the flexible cover 110, such that the flexible cover 110 may be rolled onto the storage roll 120. The roll-up decoration further comprises a roll driver mechanism 130 that is securably attached to the interior side 102 of the frame 100. The roll driver mechanism 130 is configured to rotate the storage roll 120, and thereby to move the flexible cover 110 between a deployed position and a retracted position. In the deployed position, the flexible cover 110 preferably covers the entire framed area 106, such that weighted bar 124, which is attached to the second end of the flexible cover 110, fits into recessed portion 108. In the retracted position, the flexible cover 110 is preferably rolled entirely onto the storage roll 120, and is adjacent to the interior side 102 of the frame 100.

In certain embodiments, the wall-integrated roll-up decoration for concealing objects 50 comprises a frame 100. The frame 100 further comprises an ornamental frame of the type commonly used in the framing of fine art. Such a frame may be comprised of wood, metal, polymer or any other material suitable for forming an ornamental frame. The frame 100 further comprises an interior side 102 and an exterior side 104. In a preferred embodiment, such as illustrated in FIG. 2A, the frame 100 is mounted to the exterior case of a television set 140. In other embodiments, such as embodiments wherein the television set 140 is a flat panel television set, the frame 100 further comprises a wall attachment mechanism (not shown) located on the exterior side 104 of the frame, such as a hook or a wire, for mounting the frame 100 on a wall, as illustrated in FIG. 2B. As illustrated in FIG. 1, the frame 100 defines a framed area 106.

In such embodiments, the wall-integrated roll-up decoration for concealing objects 50 further comprises a flexible cover 110 having an area 112, as illustrated in FIG. 1. The flexible cover 110 preferably comprises canvas, although in other embodiments, the flexible cover 110 comprises any non-transparent flexible material such as paper or plastic. Additionally, the area 112 is preferably greater than or equal to the framed area 106. The area 112 includes a decorative enhancement 115, such as a painting, photograph, graphical design, logo, child's drawing, fine art or any other decorative enhancement displayed on outer surface 111. In other embodiments, the area 112 includes a non-graphical display, such as a certificate, diploma or textual message. One of ordinary skill in the art will recognize that the flexible cover 110 need not be comprised of canvas, but in alternative embodiments may be comprised of paper, plastic or any other suitable material for displaying a work of art, a photograph or any other posted material.

In the preferred embodiment illustrated in FIG. 2A, the flexible cover 110 has a first end and a second end opposite the first end. In such embodiments, the first end of the flexible cover 110 is removably secured to a storage roll 120 using an adhesive, although in alternative embodiments, any other suitable attachment mechanism, such as tacks, pins or nails, may be used. The storage roll 120 comprises an elongated rigid bar, preferably cylindrical, that may be rotated around a central axis 122. The storage roll 120 may be comprised of wood, metal, polymer or any other rigid, suitable material. In such embodiments, rotation of storage roll 120 causes the flexible cover 110 to move between a deployed position (in which the flexible cover 110 is substantially unrolled from the storage roll 120) and a retracted position (in which the flexible cover 110 is rolled onto the storage roll 120). FIG. 2A illustrates the flexible cover 110 in an intermediate position 118 between the deployed position and the retracted position.

In such embodiments, placement of weighted bar 124 on the second end of the flexible cover 110 opposite the storage roll 120 facilitates the unrolling of the flexible cover 110 from the storage roll 120. Weighted bar 124 is preferably comprised of a high-density material, such as a metal, thereby preventing the flexible cover 110 from retaining a “curled” shape when in the deployed position. In a preferred embodiment, the frame 100 comprises a recessed portion 108 into which the weighted bar 124 fits when the flexible cover 110 is in the deployed position. This configuration causes the weighted bar 124 to be not visible to a person viewing the framed area 106 when the flexible cover 110 is in the deployed position. Likewise, when the flexible cover 110 is in the retracted position, the weighted bar 124 is retracted behind the frame 100, thereby causing the weighted bar 124 to be not visible to a person viewing the television set 140 when the flexible canvas cover is in the retracted position.

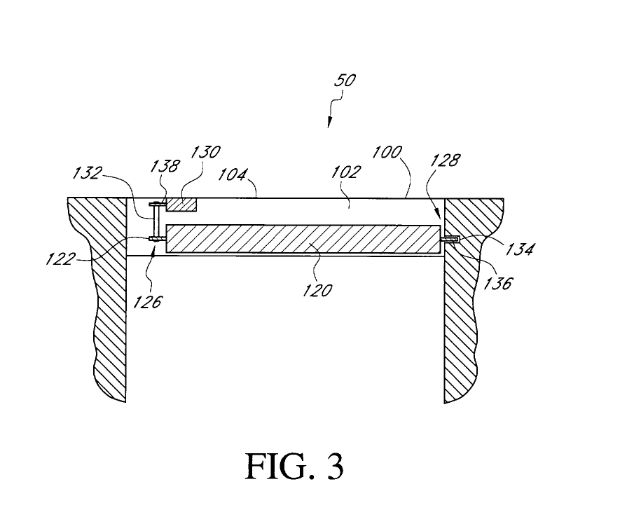

As illustrated in FIG. 3, in a preferred embodiment the storage roll 120 is supported by the interior side 102 of the frame 100 at a storage roll first end 126 and a storage roll second end 128. At the storage roll first end 126, the storage roll 120 is attached to the interior side 102 of the frame 100 via drive belt 132 and roll driver mechanism 130. At the storage roll second end 128, the storage roll 120 is attached to the interior side 102 of the frame 100 via axle pin 136 that sits in recessed portion 134.

In such embodiments, roll driver mechanism 130 is securably attached to the interior side 102 of the frame 100 using any appropriate type of attachment mechanism, such as adhesive, screws, pins or nails. The roll driver mechanism 130 is configured to rotate drive shaft 138, such as by means of a conventional bidirectional electric motor powered either by an internal power source (i.e., dry cell batteries (not shown)) or an external power source (i.e., an AC wall outlet (not shown)). In alternative embodiments, the roll driver mechanism 130 rotates the drive shaft 138 by means of a hand-driven crank case (not shown). The internal details of roll driver mechanism 130 will be known to those of ordinary skill in the art, and thus, for the sake of clarity, such details are omitted here.

Again referring to FIG. 3, in such embodiments drive shaft 138 is connected to drive belt 132, which is further connected to the central axis 122 of storage roll 120. Drive belt 132 is preferably a belt, but in alternative embodiments, is a chain, a set of gears, a wire or any other mechanism to transfer the rotational motion of drive shaft 138 to central axis 122. In a preferred embodiment, the drive shaft 138 of the roll driver mechanism 130 is directly connected to the central axis 122 of the storage roll first end 126, thereby eliminating drive belt 132. In such embodiments, the roll driver mechanism 130 is preferably integrated into the interior side 102 of the frame 100, such that the central axis 122 and the drive shaft 138 are substantially collinear.

This configuration permits the roll driver mechanism 130 to move the flexible cover 110 between the deployed position and the retracted position. In a preferred embodiment, the roll driver mechanism 130 is activated via a remote control that generates a radiofrequency or infrared activation signal that is received at a receiver stowed within the frame 100 and connected to the roll driver mechanism 130. For example, in certain embodiments, the remote control used to control the television set 140 is also configured to control the roll driver mechanism 130. Specifically, in such embodiments, the roll driver mechanism 130 is configured to actuate upon receiving a signal from the remote control that is used to toggle the on/off switch of the television set 140. Such a configuration allows a user to “uncover” and turn on his/her television set 140 with the touch of one button on his/her television set remote control. Likewise, when the user has finished watching television, simply pressing the “Power” button on his/her television set remote control will also cause the roll driver mechanism 130 to deploy the flexible cover 110 to cover the television set 140.

In alternative embodiments, the roll driver mechanism 130 is activated via a manually-operated switch or crank located on the exterior side 104 of the frame 100. Regardless of the activation means, the roll driver mechanism 130 can be activated to operate bi-directionally, thereby causing the flexible cover 110 to move between the deployed position and the retracted position at the operator's command.

In alternative embodiments, the flexible cover 110 need not use a gravitational force to aid in the movement between the deployed position and the retracted position. In such embodiments, the roll driver mechanism 130 moves the flexible cover 110 along a track (not shown) located within the frame 100. This configuration would allow the flexible cover 110 to move horizontally in FIG. 1, as well as vertically.

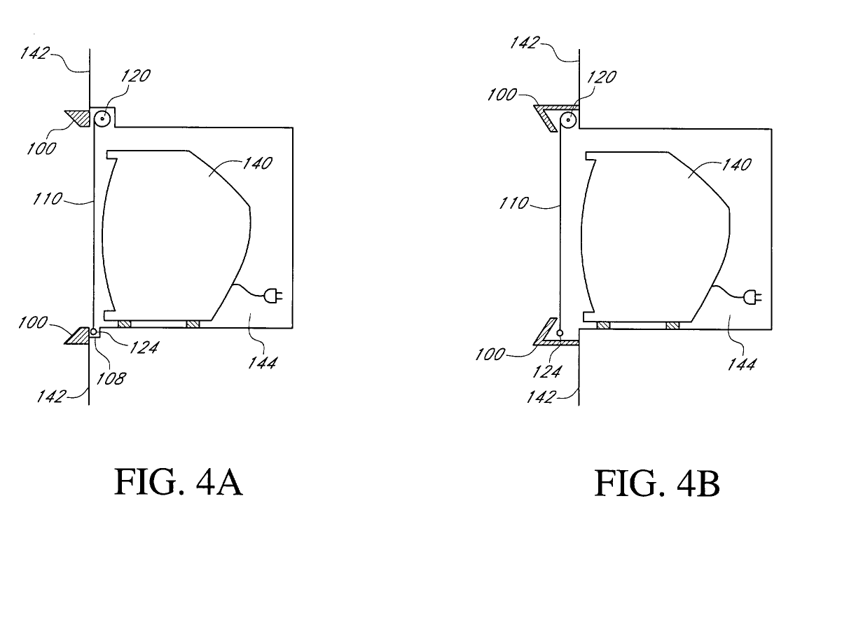

As illustrated in FIGS. 4A and 4B, in other embodiments the frame 100 is integrated with a wall 142. For example, FIG. 4A illustrates a wall 142 having a cutout shelf 144 upon which a television set 140 is placed. In such embodiments, frame 100 is mounted to the perimeter of the cutout shelf 144, such that the perimeter of the cutout shelf 144 forms a portion of the frame 100. Roll driver mechanism 130 may be integrated within the perimeter of the cutout shelf 144 or wall (as illustrated in FIG. 4A), or may be integrated within the interior side 102 of the frame 100 (as illustrated in FIG. 4B). Alternatively, roll driver mechanism 130 may be hung from the wall within or around the perimeter of the cutout shelf 144. In any of these configurations, the roll driver mechanism 130 and the weighted bar 124 are preferably positioned behind the frame 100, thereby causing them to be completely obscured from the view of a person watching the television set 140 or viewing the decorative enhancement 115 displayed on the outer surface 111 of the flexible cover 110.

In one application, illustrated in FIGS. 1 and 2A, the wall-integrated roll-up decoration for concealing objects 50 described herein is mounted on a television set 140, preferably a flat-panel television set mounted to a wall in a multipurpose room. Thus, when it is desired to use the multipurpose room for personal home video entertainment (i.e., for viewing of video recordings or television broadcasts), the roll driver mechanism 130 is activated to move the flexible cover 110 into the retracted position. When the flexible cover 110 is in the retracted position, the viewing area of the television set 140 is visible through the framed area 106, thereby allowing the television set 140 to be viewed.

Likewise, in such application, when it is desired to use the multipurpose room for a purpose that is incompatible with the presence of a television set, such as for a display of classical fine art, the roll driver mechanism 130 is activated to move the flexible cover 110 into the deployed position. When the flexible cover 110 is in the deployed position, the television set 140 is substantially, if not completely, hidden from view. Furthermore, in embodiments wherein the flexible cover 110 contains a decorative enhancement 115, such as a painting or a photograph, displayed on outer surface 111, placement of the flexible cover 110 in the deployed position appears as a piece of fine art within a frame.

In other applications, the wall-integrated roll-up decoration for concealing objects 50 may be used to conceal objects other than a television set 140. For example, referring to the embodiments illustrated in FIGS. 4A and 4B, a work of art, such as a sculpture or a three-dimensional collage may be placed on the cutout shelf 144. In such embodiments, when the flexible cover 110 is in the deployed position, decorative enhancement 115 is visible; when the flexible cover 110 is in the retracted position, the contents of the cutout shelf 144 are visible. Such embodiments are advantageous when it is desired to use a multipurpose room for display of a wide variety of items without the need to move such items to and from the room in preparation for such displays.

In addition to increasing the utility of a conventional multipurpose room as described above, the wall-integrated roll-up decoration for concealing objects 50 described herein offers several additional advantages. For example, the various embodiments described herein also serve to maximize the use of wall space available for hanging objects in a room with a limited amount of wall space. Furthermore, the various embodiments described herein also serve to protect a television set 140 by allowing its viewing area to be covered when the television set 140 is not in use. Notably, such advantages are associated with the wall-integrated roll-up decoration for concealing objects 50 regardless of whether it is used in a multipurpose room or a room configured for a single purpose. These and other advantages will be readily recognized by one of ordinary skill in the art.

### Scope of the Invention

The foregoing presents a description of certain preferred embodiments of a wall-integrated roll-up decoration for concealing objects, and of the manner and process of using it, in such full, clear, concise and exact terms as to enable any person of ordinary skill in the art to which it pertains to make and use such a system. This system is, however, susceptible to modifications and alternate configurations from those discussed above which are fully equivalent. Consequently, it is not the intention to limit this system to the particular embodiments disclosed herein. On the contrary, the intention is to cover all modifications and alternate configurations coming within the spirit and scope of the system as generally expressed by the following claims. To this end, the following claims particularly point out and distinctly claim the subject matter of the wall-integrated roll-up decoration for concealing objects.

What is claimed is:

1. An apparatus comprising:
a frame surrounding a framed area, the frame having an interior side and an exterior side opposite the interior side,
a flexible cover having an area greater than or equal to the framed area, wherein an external surface of the flexible cover includes a decorative enhancement.
a storage member connected to the flexible cover, such that the flexible cover may be moved between a deployed position, wherein the flexible cover prevents viewing of the framed area, and a retracted position, wherein the flexible cover permits viewing of the framed area.

2. The apparatus of claim 1, wherein the flexible cover comprises canvas.

3. The apparatus of claim 1, wherein the frame further comprises:
first and second horizontal framing members, and
first and second vertical framing members.

4. The apparatus of claim 3, wherein the storage member is securably attached to one of the first or second horizontal framing members.

5. The apparatus of claim 3, wherein the storage member is securably attached to one of the first or second vertical framing members.

6. The apparatus of claim 3, wherein the storage member is collinear with one of the horizontal or vertical framing members.

7. The apparatus of claim 1, wherein the frame is mounted to a television set positioned within the framed area.

8. The apparatus of claim 1, wherein the frame is mounted to an underlying wall.

9. A method of selectively covering a video display, comprising:
positioning a frame around the perimeter of the video display, the frame having an interior side and an exterior side opposite the interior side,
securably attaching a storage member to the interior side of the frame,
securably attaching a flexible cover to the storage member, the flexible cover having an exterior surface that includes a decorative enhancement.
placing the flexible cover in a first position to view the video display, and
placing the flexible cover in a second position to view the decorative enhancement.

10. The method of claim 9, wherein the flexible cover comprises canvas.

11. The method of claim 9, wherein the storage member is securably attached to the interior side of the frame.

12. The method of claim 9, wherein movement of the storage member is controlled using a remote control.

13. The method of claim 12, wherein the remote control is also configured to control operation of the video display.

14. The method of claim 9, wherein movement of the storage member is controlled using a hand-controlled crank case.

15. A method of selectively viewing a decorative enhancement or a secondary object, comprising:
providing a frame with an opening, the frame surrounding the decorative enhancement such that the decorative enhancement is viewable through the opening;
retracting the decorative enhancement without removing the frame, such that the secondary object is viewable through the opening; and
deploying the decorative enhancement to be viewable through the opening in the frame.

16. The method of claim 15, wherein the decorative enhancement is deployed to be viewable through the opening before the decorative enhancement is retracted.

17. The method of claim 15, wherein the secondary object is a television set.

18. The method of claim 15, wherein the secondary object is a three-dimensional piece of artwork.
